(19) United States
(12) Patent Application Publication
(10) Pub. No.: US 2017/0083120 A1
(43) Pub. Date: Mar. 23, 2017

(54) WIRELESS STYLUS

(71) Applicant: WALTOP INTERNATIONAL CORPORATION, HSINCHU CITY (TW)

(72) Inventor: CHIH-HUNG HUANG, HSINCHU CITY (TW)

(21) Appl. No.: 14/951,281

(22) Filed: Nov. 24, 2015

(30) Foreign Application Priority Data
Sep. 18, 2015 (TW) 104215132

(51) Int. Cl. G06F 3/0354; G09G 5/00

(52) U.S. Cl. CPC G06F 3/03545; G09G 5/006; G09G 2370/16

(57) ABSTRACT

A wireless stylus includes a stylus tube, a pressure sensor circuit, a signal transmitting circuit and a control circuit. The stylus tube includes a head portion. The pressure sensor circuit outputs a sensed pressure value according to a contact pressure of the head portion. The control circuit controls the signal transmitting circuit to transmit a wireless signal with a first duty cycle when the sensed pressure value is smaller than a pre-set value, and the control circuit controls the signal transmitting circuit to transmit the wireless signal with a second duty cycle, which is shorter than the first duty cycle, when the sensed pressure value is larger than the pre-set value. Thereby, the wireless stylus transmits a wireless signal with lower power consumption when it is being touched.

### BACKGROUND

1. Technical Field

The present invention generally relates to a stylus and, more particularly, to a wireless stylus capable of transmitting a wireless signal.

2. Description of Related Art

As touch displays have been widely used with various electronic devices, a variety of styluses have been developed accordingly. For example, magnetic styluses have been used with digital tablets and capacitive styluses have been used with capacitive touch displays. The existing wireless stylus provides, for example, adjustments of the thickness and/or the colors of the handwriting traces, electronic erasers, and other different functions, which are achieved by transmitting a wireless signal from the wireless stylus. Therefore, the wireless stylus is provided with a battery installed therein. The operating time of a wireless stylus is limited to the capacity of the battery.

### SUMMARY

The present invention provides a wireless stylus capable of lowering power consumption by adjusting transmission of a wireless signal of the wireless stylus.

One embodiment of the present invention provides a wireless stylus including a stylus tube, a pressure sensor circuit, a signal transmitting circuit and a control circuit. The stylus tube includes a head portion. The pressure sensor circuit, the signal transmitting circuit and the control circuit are disposed in the stylus tube. The pressure sensor circuit outputs a sensed pressure value according to a contact pressure of the head portion. The control circuit is electrically connected to the pressure sensor circuit and the signal transmitting circuit. The control circuit controls the signal transmitting circuit to transmit a wireless signal with a first duty cycle when the sensed pressure value is smaller than a pre-set value, and the control circuit controls the signal transmitting circuit to transmit the wireless signal with a second duty cycle when the sensed pressure value is larger than the pre-set value. The second duty cycle is shorter than the first duty cycle.

Another embodiment of the present invention provides a wireless stylus including a stylus tube, a pressure sensor circuit, a signal transmitting circuit and a control circuit. The stylus tube includes a head portion. The pressure sensor circuit, the signal transmitting circuit and the control circuit are disposed in the stylus tube. The pressure sensor circuit outputs a sensed pressure value according to a contact pressure of the head portion. The control circuit is electrically connected to the pressure sensor circuit and the signal transmitting circuit. The control circuit controls the signal transmitting circuit to transmit a wireless signal at a first transmission power level when the sensed pressure value is smaller than a pre-set value, and the control circuit controls the signal transmitting circuit to transmit the wireless signal at a second transmission power level when the sensed pressure value is larger than the pre-set value. The second transmission power level is lower than the first transmission power level.

To sum up, the present invention provides a wireless stylus capable of adjusting transmission of a wireless signal by a signal transmitting circuit according to whether the wireless stylus is touched or not. Thereby, the wireless stylus ensures that the wireless signal is successfully received while exhibiting lower power consumption and longer standby time.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of a wireless stylus according to one embodiment of the present invention;

FIG. 2A is a schematic diagram of a signal transmitting circuit according to one embodiment of the present invention;

FIG. 2B is a schematic diagram of a signal transmitting circuit according to another embodiment of the present invention;

FIG. 3A shows a waveform of a wireless signal with a first duty cycle according to one embodiment of the present invention;

FIG. 3B shows a waveform of a wireless signal with a second duty cycle according to one embodiment of the present invention; and

FIG. 4 is a flowchart of a method for operating a wireless stylus with reduced power consumption according to one embodiment of the present invention.

### DESCRIPTION OF THE EXEMPLARY EMBODIMENTS

The present invention provides a wireless stylus capable of transmitting a wireless signal to a touch display (for example, a capacitive touch display or a magnetic touch display). The wireless signal provides, for example, adjustments of the thickness and/or the colors of the handwriting traces, electronic erasers, and other different functions, to which the present invention is not limited. The types and the functions of the wireless stylus are known to the person with ordinary skill in the art, and descriptions thereof are not presented herein. Above all, the wireless stylus according to the present invention achieves power saving. Therefore, the wireless stylus determines whether it touches a touch display to further determine whether it transmits a wireless signal with reduced power consumption to the touch display.

Substantially, when the wireless stylus does not touch a touch display, it indicates that the wireless stylus is distant from the touch display. Therefore, the wireless stylus transmits a wireless signal in a normal way. On the contrary, when the wireless stylus touches a touch display, it indicates that the wireless stylus is very close to the touch display. Therefore, the wireless stylus transmits the wireless signal with reduced power. In short, the wireless stylus according to the present invention is capable of adjusting the transmission of a wireless signal based on the distance between the wireless stylus and a touch display so as to achieve power saving.

(Embodiment of Wireless Stylus)

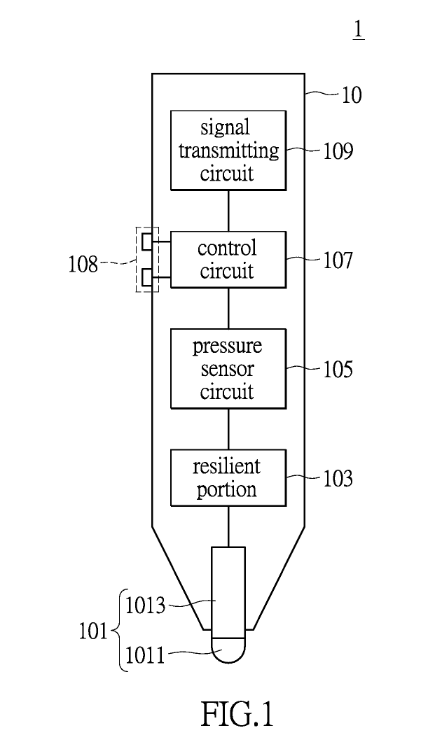

Referring to FIG. 1, FIG. 1 is a schematic diagram of a wireless stylus according to one embodiment of the present invention. The wireless stylus 1 includes a stylus tube 10, a head portion 101, a resilient portion 103, a pressure sensor circuit 105, a control circuit 107, a push-button circuit 108 and a signal transmitting circuit 109. The stylus tube 10 is a cylindrical tube for installing the head portion 101, the resilient portion 103, the pressure sensor circuit 105, the control circuit 107, the push-button circuit 108 and the signal transmitting circuit 109. The head portion 101 is disposed at one end of the stylus tube 10. The head portion 101 includes a touch tip 1011 and an anvil 1013. The touch tip 1011 is disposed outside the stylus tube 10. One end of the touch tip 1011 is coupled to the anvil 1013. The anvil 1013 extends into the stylus tube 10. The touch tip 1011 is made of conductive or non-conductive materials. The resilient portion 103 is disposed in the stylus tube 10 and is close to the head portion 101. One end of the resilient portion 103 is coupled to the anvil 1013 and the other end of the resilient portion 103 is coupled to the pressure sensor circuit 105. The control circuit 107 is electrically connected to the pressure sensor circuit 105, the push-button circuit 108 and the signal transmitting circuit 109. Moreover, the wireless stylus 1 according to the present invention achieves power saving through circuit design. The designs of the head portion 101 and the resilient portion 103 are known to the person with ordinary skill in the art, and detailed descriptions thereof are not presented herein.

Substantially, the wireless stylus 1 according to the present invention uses the pressure sensor circuit 105 to determine whether the head portion 101 touches a touch display. For example, when the wireless stylus 1 touches a touch display by the head portion 101, a contact pressure of the touch tip 1011 of the head portion 101 is transmitted through the resilient portion 103 to the pressure sensor circuit 105. The pressure sensor circuit 105 correspondingly outputs a sensed pressure value to the control circuit 107 according to the contact pressure. The control circuit 107 determines whether the head portion 101 is being touched according to the sensed pressure value and correspondingly controls the way the signal transmitting circuit 109 transmits a signal according to whether the head portion 101 is being touched.

In one embodiment, the control circuit 107 determines that the head portion 101 is not being touched and, meanwhile, the control circuit 107 controls the signal transmitting circuit 109 to transmit a wireless signal in a first mode when the sensed pressure value is smaller than a pre-set value, Moreover, the control circuit 107 determines that the head portion 101 is being touched and the control circuit 107 controls the signal transmitting circuit 109 to transmit the wireless signal in a second mode when the sensed pressure value is larger than the pre-set value. It should be noted that the first mode indicates that the signal transmitting circuit 109 transmits a wireless signal with a first duty cycle and the second mode indicates that the signal transmitting circuit 109 transmits a wireless signal with a second duty cycle. The second duty cycle is shorter than the first duty cycle. The pre-set value is, for example, a pressure value acquired by the pressure sensor circuit 105 when the head portion 101 touches a touch display.

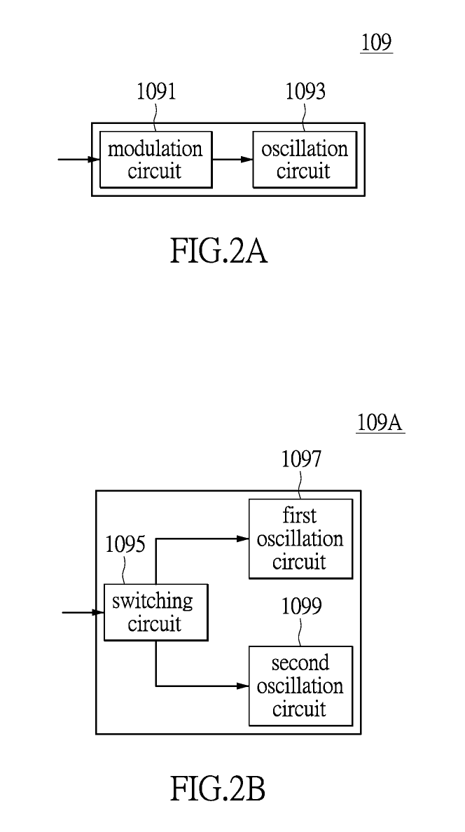

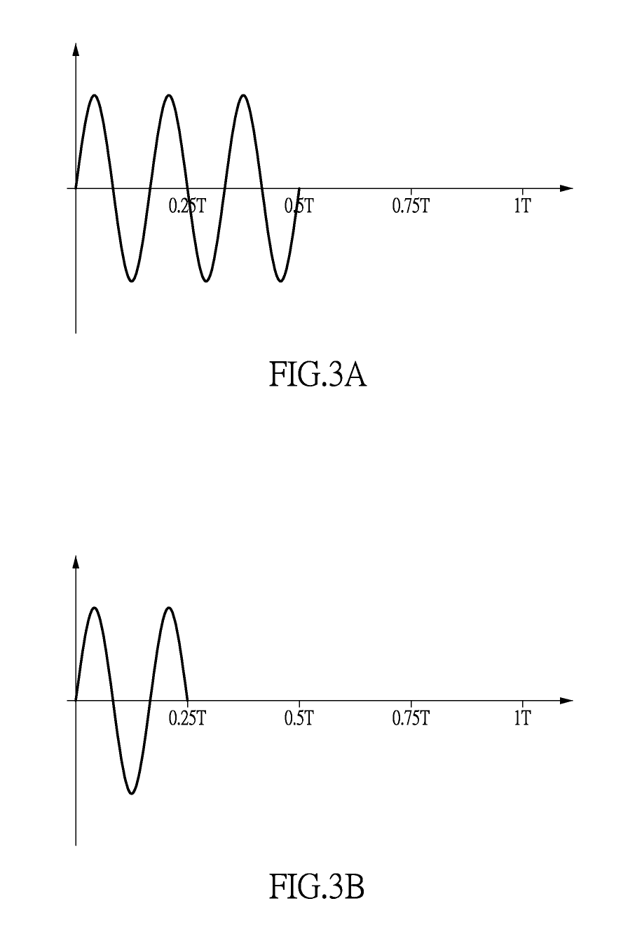

Referring to FIG. 2A, FIG. 2A is a schematic diagram of a signal transmitting circuit according to one embodiment of the present invention. The signal transmitting circuit 109 includes a modulation circuit 1091 and an oscillation circuit 1093. The modulation circuit 1091 is electrically connected to the oscillation circuit 1093. The modulation circuit 1091 correspondingly outputs an oscillation signal according to a modulation signal provided by the control circuit 107 to decide the duty cycle when the signal transmitting circuit 109 transmits a wireless signal. For example, when the sensed pressure value is smaller than the pre-set value, the control circuit 107 outputs a first modulation signal to the modulation circuit 1091. The modulation circuit 1091 outputs a first oscillation signal to the oscillation circuit 1093 according to the first modulation signal so that the oscillation circuit 1093 transmits a wireless signal with a first duty cycle. When the sensed pressure value is larger than the pre-set value, the control circuit 107 outputs a second modulation signal to the modulation circuit 1091. The modulation circuit 1091 outputs a second oscillation signal to the oscillation circuit 1093 according to the second modulation signal so that the oscillation circuit 1093 transmits a wireless signal with a second duty cycle. The first duty cycle is, for example, 0.5T as shown in FIG. 3A and the second duty cycle is, for example, 0.25T as shown in FIG. 3B. The first duty cycle being 0.5T and the second duty cycle being 0.25T are only exemplary and do not limit the scope of the present invention. In one embodiment, the second duty cycle may be adjusted based on the sensed pressure value so that the wireless stylus 1 achieves better power saving and provides sufficient strength of the wireless signal. For example, when the wireless stylus 1 touches the touch display, the second duty cycle is inversely proportional to the sensed pressure value. In other words, the larger the sensed pressure value, the shorter the second duty cycle.

Referring to FIG. 2B, FIG. 2B is a schematic diagram of a signal transmitting circuit according to another embodiment of the present invention. The signal transmitting circuit 109A includes a switching circuit 1095, a first oscillation circuit 1097 and a second oscillation circuit 1099. The switching circuit 1095 is electrically connected to the first oscillation circuit 1097 and the second oscillation circuit 1099. The switching circuit 1095 determines whether the first oscillation circuit 1097 transmits a wireless signal at a first transmission power level or the second oscillation circuit 1099 transmits a wireless signal at a second transmission power level according to whether the head portion 101 is being touched or not. The second transmission power level is lower than the first transmission power level. For example, when the sensed pressure value is smaller than the pre-set value, the control circuit 107 outputs a first switching signal to the switching circuit 1095 so that the switching circuit 1095 controls the first oscillation circuit 1097 according to the first switching signal to transmit a wireless signal at a first transmission power level. When the sensed pressure value is larger than the pre-set value, the control circuit 107 outputs a second switching signal to the switching circuit 1095 so that the switching circuit 1095 controls the second oscillation circuit 1099 according to the second switching signal to transmit a wireless signal at a second transmission power level. In one embodiment, the second transmission power level may be adjusted based on the variation of the sensed pressure value so that the wireless stylus 1 achieves better power saving and provides sufficient strength of the wireless signal. For example, when the wireless stylus 1 touches the touch display, the second transmission power level is inversely proportional to the sensed pressure value. In other words, the larger the sensed pressure value, the lower the second transmission power level.

Moreover, the push-button circuit 108 provides adjustments of the thickness and/or the colors of the handwriting traces, electronic erasers, and other different functions so that the control circuit 107 uses the signal transmitting circuit 109 to transmit a corresponding wireless signal according to the input of the push-button circuit 108. In one embodiment, the wireless stylus 1 is provided with a battery therein to supply electricity to the circuits in the wireless stylus 1.

(Power Saving Method for Wireless Stylus)

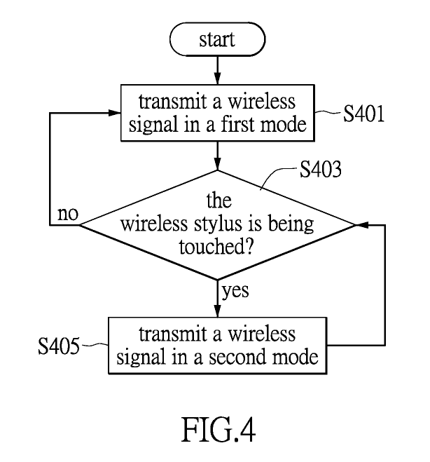

Referring to FIG. 4, FIG. 4 is a flowchart of a method for operating a wireless stylus with reduced power consumption according to one embodiment of the present invention. With reference to the wireless stylus 1 in FIG. 1, the method includes the steps as shown in FIG. 4.

In Step S401, the wireless stylus 1 transmits a wireless signal in a first mode. For example, the control circuit 107 controls the signal transmitting circuit 109 of the wireless stylus 1 to transmit a wireless signal with a first duty cycle.

In Step S403, the control circuit 107 disposed in the wireless stylus 1 determines whether the wireless stylus 1 is being touched. For example, the control circuit 107 decides whether the head portion 101 of the wireless stylus 1 is being touched according to a sensed pressure value outputted by the pressure sensor circuit 105. In one embodiment, when the sensed pressure value is smaller than a pre-set value, the control circuit 107 determines that the wireless stylus 1 is not being touched. When the sensed pressure value is larger than the pre-set value, the control circuit 107 determines that the wireless stylus 1 is being touched.

The method goes back to Step S401 when the wireless stylus 1 is determined not being touched in S403.

When the wireless stylus 1 is determined being touched in S403, the control circuit 107 controls the wireless stylus 1 to transmit a wireless signal in a second mode. For example, the control circuit 107 controls the signal transmitting circuit 109 of the wireless stylus 1 to transmit the wireless signal with a second duty cycle.

It should be noted that the second duty cycle is shorter than the first duty cycle. Accordingly, when the wireless stylus 1 does not touch a touch display, it indicates that the wireless stylus 1 is distant from the touch display. Therefore, the wireless stylus 1 transmits a wireless signal with a first duty cycle in a normal way. On the contrary, when the wireless stylus 1 touches a touch display, it indicates that the wireless stylus 1 is very close to the touch display. Therefore, the wireless stylus 1 transmits the wireless signal with a second duty cycle to reduce power consumption.

Moreover, the first mode and the second mode in Step S401 and S405 are exemplified by a first duty cycle and a second duty cycle, respectively. However, in other embodiments, the first mode may be a first transmission power level and the second mode may be a second transmission power level. The second transmission power level is lower than the first transmission power level. For example, when the wireless stylus 1 is not being touched, the signal transmitting circuit 109 of the wireless stylus 1 transmits a wireless signal at a first transmission power level in a normal way. However, when the wireless stylus 1 is being touched, the signal transmitting circuit 109 of the wireless stylus 1 transmits a wireless signal at a second transmission power level to reduce power consumption.

(Functions of the Embodiments)

To sum up, the wireless stylus 1 according to the present invention is capable of transmitting a wireless signal in a normal way when the wireless stylus 1 is distant from a touch display (i.e., the wireless stylus is not being touched) and transmitting a wireless signal with reduced power consumption when the wireless stylus 1 is very close to a touch display (i.e., the wireless stylus is being touched). Thereby, the wireless stylus ensures that the wireless signal is successfully received while exhibiting lower power consumption and longer standby time.

The above-mentioned descriptions represent merely the exemplary embodiments of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A wireless stylus, comprising:
a stylus tube comprising a head portion;
a pressure sensor circuit disposed in said stylus tube, said pressure sensor circuit outputting a sensed pressure value according to a contact pressure of said head portion;
a signal transmitting circuit disposed in said stylus tube; and
a control circuit disposed in said stylus tube, said control circuit being electrically connected to said pressure sensor circuit and said signal transmitting circuit;
wherein said control circuit controls said signal transmitting circuit to transmit a wireless signal with a first duty cycle when said sensed pressure value is smaller than a pre-set value, and said control circuit controls said signal transmitting circuit to transmit said wireless signal with a second duty cycle when said sensed pressure value is larger than said pre-set value; and
wherein said second duty cycle is shorter than said first duty cycle.

2. The wireless stylus of claim 1, wherein said signal transmitting circuit comprises an oscillation circuit, said oscillation circuit transmitting said wireless signal with said first duty cycle or said wireless signal with said second duty cycle according to an oscillation signal.

3. The wireless stylus of claim 2, wherein said signal transmitting circuit further comprises a modulation circuit, said modulation circuit being electrically connected to said oscillation circuit and said modulation circuit generating said oscillation signal according to a modulation signal outputted by said control circuit.

4. The wireless stylus of claim 1, further comprising:
a resilient portion disposed between said head portion and said pressure sensor circuit so that said pressure sensor circuit acquires said contact pressure of said head portion through said resilient portion; and
a push-button circuit electrically connected to said control circuit.

5. The wireless stylus of claim 1, wherein said head portion comprises a touch tip.

6. A wireless stylus, comprising:
a stylus tube comprising a head portion;
a pressure sensor circuit disposed in said stylus tube, said pressure sensor circuit outputting a sensed pressure value according to a contact pressure of said head portion;
a signal transmitting circuit disposed in said stylus tube; and
a control circuit disposed in said stylus tube, said control circuit being electrically connected to said pressure sensor circuit and said signal transmitting circuit;
wherein said control circuit controls said signal transmitting circuit to transmit a wireless signal at a first transmission power level when said sensed pressure value is smaller than a pre-set value, and said control circuit controls said signal transmitting circuit to transmit said wireless signal at a second transmission power level when said sensed pressure value is larger than said pre-set value; and
wherein said second transmission power level is smaller than said first transmission power level.

7. The wireless stylus of claim 6, wherein said signal transmitting circuit comprises a first oscillation circuit and a second oscillation circuit, said first oscillation circuit transmitting said wireless signal at said first transmission power level and said second oscillation circuit transmitting said wireless signal at said second transmission power level.

8. The wireless stylus of claim 7, wherein said signal transmitting circuit further comprises a switching circuit, said switching circuit being electrically connected to said first oscillation circuit and said second oscillation circuit, said switching circuit controls said first oscillation circuit or said second oscillation circuit to transmit said wireless signal according to a switching signal outputted by said control circuit.

9. The wireless stylus of claim 6, further comprising:
a resilient portion disposed between said head portion and said pressure sensor circuit so that said pressure sensor circuit acquires said contact pressure of said head portion through said resilient portion; and
a push-button circuit electrically connected to said control circuit.

10. The wireless stylus of claim 6, wherein said head portion comprises a touch tip.
